(19) United States
(12) Patent Application Publication
(10) Pub. No.: US 2026/0201150 A1
(43) Pub. Date: Jul. 16, 2026

(54) PREPARATION METHOD FOR FLAME RETARDANT AND EPOXY RESIN COMPOSITE MATERIAL

(71) Applicant: Nanjing Tech University, Nanjing City (CN)

(72) Inventors: Zhirong Wang, Nanjing City (CN); Li Li, Nanjing City (CN); Junling Wang, Nanjing City (CN); Konghao Yu, Nanjing City (CN); Xuecheng Sun, China (CN); Xuetao Sun, Nanjing City (CN); Yawei Lu, Nanjing City (CN)

(21) Appl. No.: 19/439,416

(22) Filed: Jan. 4, 2026

(30) Foreign Application Priority Data
Jan. 15, 2025 (CN) 202510065072.2

(51) Int. Cl. C08K 9/06; B29B 7/04; B29C 39/00; B29K 63/00; B29K 105/00; C08J 3/205

(52) U.S. Cl. CPC C08K 9/06; C08J 3/2056; B29B 7/04; B29C 39/003; B29K 2063/00; B29K 2105/0026; C08J 2363/00

(57) ABSTRACT

Disclosed in the present invention is a preparation method for a flame retardant and an epoxy resin composite material. The preparation method for the flame retardant includes: performing silane modification on MXene; preparing a MXene dispersion; dissolving a certain amount of phosphorus-chlorine bond-rich modifier and acid scavenger in tetrahydrofuran, and adding the mixture into the MXene dispersion after complete dissolution; dissolving a certain amount of hexachlorocyclotriphosphazene and organic amine in tetrahydrofuran, and slowly adding dropwise into the mixed solution after dissolution; after completion of the reaction, filtering to obtain the product, washing the product with tetrahydrofuran and water, respectively, multiple times, and drying the product in a vacuum oven to obtain the flame retardant. The flame retardant prepared according to the present invention achieves superior flame retardancy at a lower loading content. Under the same loading content, the peak smoke production rate and the peak CO generation rate of the epoxy resin composite material prepared according to the present invention both decrease significantly.

### TECHNICAL FIELD

The present invention belongs to the technical field of flame retardant composite materials, and specifically relates to a preparation method for a flame retardant and an epoxy resin composite material.

### BACKGROUND ART

Epoxy resin (EP) is a typical thermosetting polymer; cured EP exhibits good chemical stability, mechanical properties, electrical insulation properties, and high adhesion properties. Because of its excellent comprehensive performance, it has been widely used in the electronics industry, coatings, transportation, and civil construction. However, EP, like most polymers, is primarily composed of C, H, and O, and is highly flammable, generating substantial heat and toxic smoke upon combustion.

Titanium carbide nanosheets (MXene) are a novel graphene-like two-dimensional nanomaterial with a unique layered structure and excellent thermal stability, exhibiting good flame-retardant potential. However, MXene exhibits issues including secondary agglomeration, reduced flame retardancy efficiency, and degraded mechanical performance of the composite material. Therefore, it is of great significance to modify MXene to improve its compatibility with the polymer matrix and further enhance the fire safety performance of the polymer without compromising other properties, such as mechanical properties.

### SUMMARY OF THE INVENTION

The present invention designs a functionalized MXene flame retardant (H-MX) and prepares an epoxy resin composite material via nanocomposite technology to reduce the release of heat and toxic smoke during combustion of the composite material.

A preparation method for a flame retardant, including the following steps:
step 1: performing silane modification on MXene;
step 2: dispersing the modified MXene prepared in step 1 in tetrahydrofuran to obtain an MXene dispersion;
step 3: dissolving a certain amount of phosphorus-chlorine bond-rich modifier and acid scavenger in tetrahydrofuran, after complete dissolution, adding the mixture into the MXene dispersion in step 2;
step 4: dissolving a certain amount of hexachlorocyclotriphosphazene and organic amine in tetrahydrofuran, after dissolution, slowly adding dropwise into the mixed solution in step 3;
step 5: after completion of the reaction, filtering to obtain the product, washing the product with tetrahydrofuran and water, respectively, multiple times, and drying the product in a vacuum oven to obtain the flame retardant.

Preferably, the phosphorus-chlorine bond-rich modifier in step 3 is one or two selected from hexachlorocyclotriphosphazene, phosphorus oxychloride, phosphorus pentachloride, pyrophosphoryl chloride, diphenyl phosphoryl chloride, phenyl phosphoryl dichloride, and diethylphosphinyl chloride.

Preferably, the organic amine compound in step 4 is one or two selected from p-phenylenediamine, diphenylamine thiol, melamine, 4,4-diaminodiphenyl ether, 4,4-diaminodiphenyl sulfone, and trimethoxypyrimidine.

Preferably, the phosphorus-chlorine bond-rich modifier in step 3 is hexachlorocyclotriphosphazene, the acid scavenger is triethylamine, and the organic amine compound in step 4 is p-phenylenediamine.

Preferably, the mass ratio of the modified MXene to hexachlorocyclotriphosphazene, p-phenylenediamine, and triethylamine is 1:(5-7):(5-7):(9.5-13.5).

A preparation method for a flame retardant, specifically including:
step 1, weighing 1 g of MXene and dispersing it in a mixed solution consisting of 60 ml of ethanol and 240 ml of water, keeping ultrasonic stirring under low-temperature conditions, then adding 20 ml of 3-aminopropyltriethoxysilane and keeping continuing stirring; after completion of the reaction, centrifugally washing with water and ethanol, respectively, to obtain modified MXene;
step 2: weighing 1 g of the modified MXene prepared in step 1 and dispersing it in 50 ml of tetrahydrofuran, keeping ultrasonic stirring at a low temperature to obtain an MXene dispersion;
step 3: dissolving 4 g of hexachlorocyclotriphosphazene and 11.5 g of triethylamine in 20 ml of tetrahydrofuran, and after complete dissolution, adding the above MXene dispersion and continuing ultrasonic stirring;
step 4: dissolving 2.0 g of hexachlorocyclotriphosphazene and 6.0 g of p-phenylenediamine in 30 ml of tetrahydrofuran, and after dissolution, slowly adding dropwise into the mixed solution in step 3 and keeping ultrasonic stirring; after completion of ultrasonic stirring, placing the mixed solution in an oil bath and reacting at 50° C. for 12 h;
step 5: after completion of the reaction, filtering to obtain the product, washing the product with tetrahydrofuran and water, respectively, three times, and drying the product in a vacuum oven at 50° C. to obtain the flame retardant.

The surface modifier used for modifying MXene may be one of 3-aminopropyltriethoxysilane, tributylaminomethylsilane, 3-aminopropyltrihydroxysilane, (3-aminopropyl) trimethoxysilane, or 3-aminopropylmethyldimethoxysilane.

A preparation method for an epoxy resin composite material, including the following steps: step 1: performing silane modification on MXene;
step 2: dispersing the modified MXene prepared in step 1 in tetrahydrofuran to obtain an MXene dispersion;
step 3: dissolving a certain amount of phosphorus-chlorine bond-rich modifier and acid scavenger in tetrahydrofuran, after complete dissolution, adding the mixture into the MXene dispersion in step 2;
step 4, dissolving a certain amount of a phosphorus-chlorine bond-rich modifier and an organic amine in tetrahydrofuran, after dissolution, slowly adding dropwise into the mixed solution in step 3;
step 5: after completion of the reaction, filtering to obtain the product, washing the product with tetrahydrofuran and water, respectively, multiple times, and drying the product in a vacuum oven to obtain the flame retardant;
step 6, adding a certain amount of the flame retardant and acetone into a flask and mixing;
step 7, heating the epoxy resin to melting, weighing a certain amount of the melted epoxy resin, and adding it to the flask from step 6, placing the flask in an oil bath, and stirring to volatilize the acetone;
step 8, heating a certain amount of curing agent in a beaker until being melted, adding it to the flask in step 7 and mixing uniformly, pouring the mixture into a mold, and drying in an oven to obtain a composite material.

The curing agent may be selected from one of 4,4-diaminodiphenylmethane, phthalic anhydride, trimellitic anhydride, pyromellitic dianhydride, and methyltetrahydrophthalic anhydride.

Preferably, the loading content of the flame retardant is 2-4 wt % of the total mass of the epoxy resin composite material.

A preparation method for an epoxy resin composite material, including the following steps: step 1, weighing 1 g of MXene and dispersing it in a mixed solution consisting of 60 ml of ethanol and 240 ml of water, keeping ultrasonic stirring under low-temperature conditions, then adding 20 ml of 3-aminopropyltriethoxysilane and keeping continuing stirring; after completion of the reaction, centrifugally washing with water and ethanol, respectively, to obtain modified MXene;
step 2: weighing 1 g of the modified MXene prepared in step 1 and dispersing it in 50 ml of tetrahydrofuran, keeping ultrasonic stirring at a low temperature to obtain an MXene dispersion;
step 3: dissolving 4 g of hexachlorocyclotriphosphazene and 11.5 g of triethylamine in 20 ml of tetrahydrofuran, and after complete dissolution, adding the above MXene dispersion and continuing ultrasonic stirring;
step 4: dissolving 2.0 g of hexachlorocyclotriphosphazene and 6.0 g of p-phenylenediamine in 30 ml of tetrahydrofuran, and after dissolution, slowly adding dropwise into the mixed solution in step 3 and keeping ultrasonic stirring; after completion of ultrasonic stirring, placing the mixed solution in an oil bath and reacting at 50° C. for 12 h;
step 5: after completion of the reaction, filtering to obtain the product, washing the product with tetrahydrofuran and water, respectively, three times, and drying the product in a vacuum oven at 50° C. to obtain the flame retardant;
Step 6, adding 2 g of the flame retardant in step 5 and a certain amount of acetone into a flask, and keeping ultrasonic stirring;
step 7, placing the epoxy resin in an oven and heating at 80° C. until being melted, weighing 80.4 g of the melted epoxy resin, and adding it to the flask in step 6, continuing ultrasonic stirring, and after completion of ultrasonic treatment, placing the flask in an oil bath and stirring to volatilize the acetone at 90° C.;
step 8, grinding 17.6 g of 4,4-diaminodiphenylmethane into fine powder, placing it in a beaker, heating at 120° C. until being melted, and adding it to the flask in step 7; after uniform mixing, pouring the mixture into a mold and drying in an oven at 100° C. and 150° C., respectively, to obtain a composite material, wherein the loading content of the flame retardant is 2 wt % of the total mass of the epoxy resin composite material.

The advantageous effects of the present invention are as follows:

The flame retardant prepared according to the present invention achieves superior flame retardancy at a lower loading content. Under the same loading content, the peak smoke production rate and the peak CO generation rate of the epoxy resin composite material prepared according to the present invention both decrease significantly. The flame retardant composite material prepared according to the present invention not only exhibits superior fire safety performance but also demonstrates excellent mechanical properties.

### BRIEF DESCRIPTION OF THE DRAWINGS

FIG. 1 shows the mechanical property test results of pure EP and the epoxy resin composite material prepared according to the present invention.

### DETAILED DESCRIPTION OF THE INVENTION

To further illustrate the technical solution of the present invention, preferred embodiments of the present invention are described below with reference to specific examples; however, it should be understood that such descriptions serve only to further elucidate the features and advantages of the present invention and are not intended to limit the scope of the claims of the present invention. Based on the embodiments disclosed herein, all other embodiments that would be readily apparent to a person skilled in the art without exercising inventive effort fall within the scope of protection of the present invention.

Unless otherwise specified, all raw materials or reagents mentioned below are commercially available products, and all process steps or methods not explicitly described are conventional techniques known to those skilled in the art.

Sources of certain raw materials and reagents used in the following Examples, Test Examples, and Comparative Examples are listed below:
MXene, purchased from Jilin 11 Technology Co., Ltd.;
3-aminopropyltriethoxysilane, purchased from Shanghai Macklin Biochemical Technology Co., Ltd.;
hexachlorocyclotriphosphazene, purchased from Shanghai Macklin Biochemical Technology Co., Ltd.;
triethylamine, purchased from Sinopharm Chemical Reagent Co., Ltd.;
p-Phenylenediamine, purchased from Shanghai Macklin Biochemical Technology Co., Ltd.;
tetrahydrofuran, purchased from Shanghai Macklin Biochemical Technology Co., Ltd.;
epoxy resin, purchased from Shandong Tianmao New Material Technology Co., Ltd.;
4,4-diaminodiphenyl methane (DDM), purchased from Shanghai Macklin Biochemical Technology Co., Ltd.;
acetone, purchased from Sinopharm Chemical Reagent Co., Ltd.

### Example 1

Example 1 describes the specific preparation process of the flame retardant according to the present invention:
step 1, 1 g of MXene was weighed and dispersed in a mixed solution consisting of 60 ml of ethanol and 240 ml of water, ultrasonic stirring under low-temperature conditions was performed for 1 h, 20 ml of 3-aminopropyltriethoxysilane was added, and continuing stirring was kept for 24 h. After completion of the reaction, the mixture was centrifugally washed with water and ethanol, respectively, to obtain modified MXene.
Step 2:1 g of the modified MXene prepared in step 1 was weighed and dispersed in 50 ml of tetrahydrofuran, ultrasonic stirring at a low temperature was kept for 20 min to obtain an MXene dispersion.
Step 3:4 g of hexachlorocyclotriphosphazene and 11.5 g of triethylamine were dissolved in 20 ml of tetrahydrofuran, and after complete dissolution, the above MXene dispersion was added, and continuing ultrasonic stirring was performed for 20 min.
Step 4:2.0 g of hexachlorocyclotriphosphazene and 6.0 g of p-phenylenediamine were dissolved in 30 ml of tetrahydrofuran, and after dissolution, the mixture was slowly added dropwise into the mixed solution in step 3, and ultrasonic stirring was kept for 1 h. After completion of ultrasonic stirring, the mixed solution was placed in an oil bath and reacted at 50° C. for 12 h.

Hexachlorocyclotriphosphazene is grafted onto the modified MXene via a substitution reaction, with triethylamine serving as an acid scavenger. The addition of p-phenylenediamine is intended to react with the already grafted hexachlorocyclotriphosphazene, and additional hexachlorocyclotriphosphazene is added to fully consume the p-phenylenediamine, thereby forming a macromolecular structure.
step 5: after completion of the reaction, the product was obtained by filtering, then washed with tetrahydrofuran and water, respectively, three times, and the product was dried in a vacuum oven at 50° C. to obtain the flame retardant H-MX-1.

The mass ratio of modified MXene to hexachlorocyclotriphosphazene, p-phenylenediamine, and triethylamine was 1 g: 6 g: 6 g: 11.5 g.

### Example 2

Example 2 differs from Example 1 only in that the mass ratio of modified MXene to hexachlorocyclotriphosphazene, p-phenylenediamine, and triethylamine was 1 g: 5 g: 5 g: 9.5 g; i.e., 3.4 g of hexachlorocyclotriphosphazene and 9.5 g of triethylamine are added in step 3, and 1.6 g of hexachlorocyclotriphosphazene and 5.0 g of p-phenylenediamine were added in step 4, to obtain the flame retardant H-MX-2.

### Example 3

Example 3 differs from Example 1 only in that the mass ratio of modified MXene to hexachlorocyclotriphosphazene, p-phenylenediamine, and triethylamine was 1 g: 7 g: 7 g: 13.5 g; i.e., 4.7 g of hexachlorocyclotriphosphazene and 13.5 g of triethylamine are added in step 3, and 2.3 g of hexachlorocyclotriphosphazene and 7.0 g of p-phenylenediamine were added in step 4, to obtain the flame retardant H-MX-3.

### Comparative Example 1

Comparative Example 1 differs from Example 1 only in that the mass ratio of modified MXene to hexachlorocyclotriphosphazene, p-phenylenediamine, and triethylamine was 1 g: 3 g: 3 g: 5.8 g; i.e., 2.0 g of hexachlorocyclotriphosphazene and 5.8 g of triethylamine are added in step 3, and 1.0 g of hexachlorocyclotriphosphazene and 3.0 g of p-phenylenediamine were added in step 4, to obtain the flame retardant H-MX-4.

### Comparative Example 2

Comparative Example 2 differs from Example 1 only in that the mass ratio of modified MXene to hexachlorocyclotriphosphazene, p-phenylenediamine, and triethylamine was 1 g: 8 g: 8 g: 15.4 g; i.e., 5.4 g of hexachlorocyclotriphosphazene and 15.4 g of triethylamine are added in step 3, and 2.6 g of hexachlorocyclotriphosphazene and 8.0 g of p-phenylenediamine were added in step 4, to obtain the flame retardant H-MX-5.

The loading contents of each component of the flame retardants in the above Examples and Comparative Examples are shown in Table 1:

TABLE 1
Loading contents of each component of the flame retardants
in the above Examples and Comparative Examples

| | Modified | Hexachlorocy- | p-Phenyl- | Trieth- | |
|---|---|---|---|---|---|
| Examples | MXene | clotriphosphazene | enediamine | ylamine | |
| Example 1 | 1 g | 6 g | 6 g | 11.5 | g |
| Example 2 | 1 g | 5 g | 5 g | 9.5 | g |
| Example 3 | 1 g | 7 g | 7 g | 13.5 | g |
| Comparative | 1 g | 3 g | 3 g | 5.8 | g |
| Example 1 | | | | | |
| Comparative | 1 g | 8 g | 8 g | 15.4 | g |

Example 2

### Example 4

Example 4 is a preparation method of the epoxy resin composite material according to the present invention. For convenience of description, epoxy resin is denoted as EP, and the specific process is as follows:
Step 1:2 g of H-MX-1 prepared in Example 1 and a certain amount of acetone were added into a flask, and ultrasonic stirring was kept for 1 h.
Step 2: EP was placed in an oven and heated at 80° C. until being melted; then 80.4 g of the melted EP was weighed and added to the flask in step 1, followed by continued ultrasonic stirring for 1 h. After ultrasonic treatment, the flask was placed in an oil bath, and the mixture was stirred to evaporate the acetone at 90° C. for 3 h.
Step 3:17.6 g of 4,4-diaminodiphenylmethane (DDM) was ground into a fine powder, transferred to a beaker, and heated at 120° C. until completely melted, the molten DDM was then added to the flask in Step 2. After uniform mixing, the mixture was poured into a mold and dried in an oven at 100° C. and 150° C. for 2 h, namely, dried at 100° C. for 2 h, the temperature was then increased to 150° C. for an additional 2 h of drying, to obtain the composite material EP/2.0H-MX-1, where the loading content of the H-MX-1 flame retardant was 2 wt % relative to the total mass of the epoxy resin composite material.

### Example 5

Example 5 differs from Example 4 only in that an EP composite material was obtained by using H-MX-2 prepared in Example 2 instead of H-MX-1 prepared in Example 1.

### Example 6

Example 6 differs from Example 4 only in that an EP composite material was obtained by using H-MX-3 prepared in Example 3 instead of H-MX-1 prepared in Example 1.

### Comparative Example 3

Comparative Example 3 differs from Example 4 in that an EP composite material was obtained by using H-MX-4 prepared in Comparative Example 1 in place of H-MX-1 prepared in Example 1.

### Comparative Example 4

Comparative Example 4 differs from Example 4 in that an EP composite material was obtained by replacing the H-MX-1 prepared in Example 1 with the H-MX-5 prepared in Comparative Example 2.

### Example 7

This Example 7 differs from Example 4 in that the H-MX-1 flame retardant prepared in Example 1 had a loading content of 3 wt % based on the total mass of the epoxy resin composite material.

### Example 8

This Example 8 differs from Example 4 in that the H-MX-1 flame retardant prepared in Example 1 had a loading content of 4 wt % based on the total mass of the epoxy resin composite material.

### Comparative Example 5

Comparative Example 5 differs from Example 4 in that the H-MX-1 flame retardant prepared in Example 1 had a loading content of 1 wt % based on the total mass of the epoxy resin composite material.

### Comparative Example 6

Comparative Example 6 differs from Example 4 in that the H-MX-1 flame retardant prepared in Example 1 had a loading content of 6 wt % based on the total mass of the EP composite material.

### Comparative Example 7

Comparative Example 7 is a preparation method of pure EP without the addition of any flame retardant, and the specific process is as follows: the EP was placed in an oven and heated at 80° C. until being melted; then, 82.1 g of EP was added to the flask and stirred at 90° C. 17.9 g of DDM was taken and ground into a fine powder, and placed in a beaker. The DDM was heated at 120° C. until complete melting, then transferred into a flask. After mixing well, the mixture was poured into a mold and placed in an oven to dry at 100° C. and 150° C. for 2 h, respectively, to obtain flame-retardant-free EP.

### Test Example 1: Limiting Oxygen Index Test

The specific testing procedure is as follows: samples of Examples 4-8 and Comparative Examples 3-7 were tested using an oxygen index meter.

The limiting oxygen index refers to the minimum volume fraction of oxygen in an oxygen-nitrogen mixture gas required to support combustion of a polymer, and it is an index characterizing the combustibility of materials. Materials with a high limiting oxygen index are difficult to ignite; materials with a limiting oxygen index above 27% are generally classified as flame-retardant, whereas those below 20% are classified as flammable. The test results are shown in Table 2 below:

TABLE 2
Limiting oxygen index test results

| | | | Limiting |
|---|---|---|---|
| | Adding a flame | Loading | oxygen |
| Samples | retardant | content | index (LOI) |
| Example 4 | H-MX-1 | 2 wt % | 27.20% |
| Example 5 | H-MX-2 | 2 wt % | 27.13% |
| Example 6 | H-MX-3 | 2 wt % | 27.08% |
| Comparative Example 3 | H-MX-4 | 2 wt % | 26.35% |
| Comparative Example 4 | H-MX-5 | 2 wt % | 26.52% |
| Example 7 | H-MX-1 | 3 wt % | 27.78% |
| Example 8 | H-MX-1 | 4 wt % | 28.05% |
| Comparative Example 5 | H-MX-1 | 1 wt % | 26.54% |
| Comparative Example 6 | H-MX-1 | 6 wt % | 26.93% |
| Comparative Example 7 | Not available | Not available | 22.15% |

As can be seen from Table 2, the LOI of pure EP is only 22.15%, indicating that EP is highly flammable. With the addition of 2 wt % H-MX-1, the LOI value of the composite material prepared in Example 4 increased to 27.20%, indicating its excellent flame-retardant properties. The composite materials prepared in Examples 5 and 6 also exhibited excellent flame-retardant properties, whereas those prepared in Comparative Examples 3 and 4 exhibited poor flame-retardant properties. For Comparative Example 1, the loading contents of hexachlorocyclotriphosphazene, triethylamine, and p-phenylenediamine were too low, resulting in insufficient macromolecules grafted onto the surface of the modified MXene; thus, the agglomeration of MXene could not be mitigated, leading to an uneven distribution of the flame retardant in the EP matrix and poor flame retardancy. For Comparative Example 2, excessive loading contents of hexachlorocyclotriphosphazene, triethylamine, and p-phenylenediamine resulted in excessive macromolecular grafting onto the modified MXene surface. However, excessive macromolecules promote the decomposition of the EP matrix and aggravate combustion, causing the composite material to exhibit poor flame retardancy. Therefore, in comparison, the flame retardants H-MX-1, H-MX-2, and H-MX-3 prepared in Examples 1, 2, and 3 exhibit superior flame retardant performance.

The composite materials also exhibit different properties at different flame retardant loading contents. Comparative Example 5 exhibits a limiting oxygen index of less than 27.0% due to insufficient loading content of H-MX-1. In Comparative Example 6, excessive loading content of H-MX-1 may lead to non-uniform dispersion in the EP matrix, resulting in an oxygen index of less than 27.0% and poor flame retardancy. In contrast, after adding 2 wt %, 3 wt %, and 4 wt % H-MX-1, the LOI values of the composite materials prepared in Examples 4, 7, and 8 all exceed 27.0%, indicating excellent flame retardancy.

### Test Example 2: Cone Calorimetry Test

The specific testing procedure is as follows: according to ISO 5660, burning tests were performed on samples using a cone calorimeter (UK, Fire Testing Technology); the sample dimensions were 100×100×3 mm³, and the specific samples were Example 4, Example 7, Example 8, and Comparative Example 7. The test results are shown in Table 3 below:

TABLE 3
Cone calorimetry test results

| | Adding | | | | |
|---|---|---|---|---|---|
| | a flame | Loading | PHRR | PSPR | PCOP |
| Samples | retardant | content | (kW/m²) | (m²/s) | (g/s) |
| Example 4 | H-MX-1 | 2 wt % | 851.1 | 0.19 | 0.02 |
| EP/2.0 H-MX-1 | | | | | |
| Example 7 | H-MX-1 | 3 wt % | 791.2 | 0.22 | 0.02 |
| EP/3.0 H-MX-1 | | | | | |
| Example 8 | H-MX-1 | 4 wt % | 751.0 | 0.23 | 0.02 |
| EP/4.0 H-MX-1 | | | | | |
| Comparative | Not | Not | 1097.2 | 0.62 | 0.05 |
| Example 7 EP | available | available | | | |

Where PHHR refers to the peak heat release rate, PSPR refers to the peak smoke production rate, and PCOP refers to the peak CO production rate.

As can be seen from Table 3, upon ignition, EP rapidly releases a large amount of heat and reaches the peak heat release rate within a short time, accompanied by substantial smoke emission. After the addition of 2 wt % H-MX-1, the release of heat, smoke, and CO from the composite material is significantly reduced. Compared with pure EP, the peak heat release rate, peak smoke production rate, and peak CO generation rate of EP/2.0H-MX-1 decrease by 22.4%, 69.4%, and 63.3%, respectively. Upon addition of 4 wt % H-MX-1, the peak heat release rate, peak smoke production rate, and peak CO generation rate of EP/4.0 H-MX-1 decrease by 31.6%, 62.9%, and 57.1%, respectively. All the above results indicate that the fire safety performance of the EP composite material is significantly improved by incorporating H-MX-1.

In prior art 1 (patent No. ZL202111188005.8, titled “TERNARY NANOCOMPOSITE FLAME RETARDANT, FLAME-RETARDANT EPOXY RESIN, AND PREPARATION METHOD THEREOF”), the peak smoke production rate of the composite material decreases by 41.3% upon addition of 6 wt % CLMXene, whereas in the present invention, the peak smoke production rate of the composite material decreases by 69.4% upon addition of 2 wt % H-MX, clearly outperforming prior art 1. In prior art 2 (patent No. ZL202210697803.1, titled “PREPARATION OF FUNCTIONALIZED TITANIUM CARBIDE NANO FLAME RETARDANT AND USE THEREOF IN EPOXY RESIN”), the peak CO generation rate of the composite material decreases by 40.6% upon addition of 2 wt % MX-Fe@LDH, whereas in the present invention, the peak CO generation rate of the composite material decreases by 63.3% upon addition of 2 wt % H-MX, clearly outperforming prior art 2.

### Test Example 3: Flexural Mechanical Property Test

The specific testing procedure is as follows: mechanical properties were tested using a universal tensile tester (CMT4204, MTS Systems Co., Ltd., China); the samples were in the form of long strips, and the test was conducted at a bending rate of 2 mm/min according to the standard. The specific samples were Example 4, Example 7, Example 8, and Comparative Example 7.

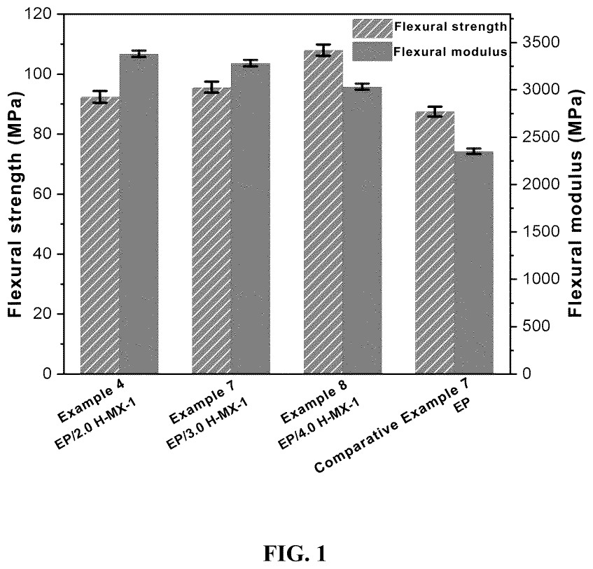

It can be seen from FIG. 1 that the addition of H-MX-1 enhances the flexural properties of the composite material. Compared with pure EP, the flexural strength and flexural modulus of EP/4.0 H-MX-1 increase by 20.9% and 29.0%, respectively.

1. A preparation method for a flame retardant, characterized by comprising following steps:
step 1: performing silane modification on MXene;
step 2: dispersing the modified MXene prepared in step 1 in tetrahydrofuran to obtain an MXene dispersion;
step 3: dissolving a certain amount of phosphorus-chlorine bond-rich modifier and acid scavenger in tetrahydrofuran, after complete dissolution, adding the mixture into the MXene dispersion in step 2;
step 4: dissolving a certain amount of hexachlorocyclotriphosphazene and organic amine in tetrahydrofuran, after dissolution, slowly adding dropwise into the mixed solution in step 3;
step 5: after completion of the reaction, filtering to obtain the product, washing the product with tetrahydrofuran and water, respectively, multiple times, and drying the product in a vacuum oven to obtain the flame retardant.

2. The preparation method for a flame retardant according to claim 1, characterized in that the phosphorus-chlorine bond-rich modifier in step 3 is one or two selected from hexachlorocyclotriphosphazene, phosphorus oxychloride, phosphorus pentachloride, pyrophosphoryl chloride, diphenyl phosphoryl chloride, phenyl phosphoryl dichloride, and diethylphosphinyl chloride.

3. The preparation method for a flame retardant according to claim 2, characterized in that the organic amine compound in step 4 is one or two selected from p-phenylenediamine, diphenylamine thiol, melamine, 4,4-diaminodiphenyl ether, 4,4-diaminodiphenyl sulfone, and trimethoxypyrimidine.

4. The preparation method for a flame retardant according to claim 3, characterized in that the phosphorus-chlorine bond-rich modifier in step 3 is hexachlorocyclotriphosphazene, the acid scavenger is triethylamine, and the organic amine compound in step 4 is p-phenylenediamine.

5. The preparation method for a flame retardant according to claim 4, characterized in that the mass ratio of the modified MXene to hexachlorocyclotriphosphazene, p-phenylenediamine, and triethylamine is 1:(5-7):(5-7):(9.5-13.5).

6. A preparation method for a flame retardant, characterized by comprising following steps:
step 1: weighing 1 g of MXene and dispersing it in a mixed solution consisting of 60 ml of ethanol and 240 ml of water, keeping ultrasonic stirring under low-temperature conditions, then adding 20 ml of 3-aminopropyltriethoxysilane, and keeping continuing stirring; after completion of the reaction, centrifugally washing with water and ethanol, respectively, to obtain modified MXene;
step 2: weighing 1 g of the modified MXene prepared in step 1 and dispersing it in 50 ml of tetrahydrofuran, keeping ultrasonic stirring at a low temperature to obtain an MXene dispersion;
step 3: dissolving 4 g of hexachlorocyclotriphosphazene and 11.5 g of triethylamine in 20 ml of tetrahydrofuran, and after complete dissolution, adding the above MXene dispersion and continuing ultrasonic stirring;
step 4: dissolving 2.0 g of hexachlorocyclotriphosphazene and 6.0 g of p-phenylenediamine in 30 ml of tetrahydrofuran, and after dissolution, slowly adding dropwise into the mixed solution in step 3 and keeping ultrasonic stirring; after completion of ultrasonic stirring, placing the mixed solution in an oil bath and reacting at 50° C. for 12 h;
step 5: after completion of the reaction, filtering to obtain the product, washing the product with tetrahydrofuran and water, respectively, three times, and drying the product in a vacuum oven at 50° C. to obtain the flame retardant.

7. A preparation method for an epoxy resin composite material according to claim 1, characterized by comprising following steps:
step 1: adding a certain amount of the flame retardant prepared according to claim 1 and acetone into a flask and mixing;
step 2: heating epoxy resin to melting, weighing a certain amount of the melted epoxy resin, and adding it to the flask from step 1, placing the flask in an oil bath, and stirring to volatilize the acetone;
step 3: heating a certain amount of curing agent in a beaker until being melted, adding it to the flask in step 2 and mixing uniformly, pouring the mixture into a mold, and drying in an oven to obtain a composite material.

8. The preparation method for an epoxy resin composite material according to claim 7, characterized in that the loading content of the flame retardant is 2-4 wt % of the total mass of the epoxy resin composite material.

9. A preparation method for an epoxy resin composite material according to claim 6, characterized by comprising following steps:
step 1: adding 2 g of the flame retardant prepared according to claim 6 and a certain amount of acetone into a flask, and keeping ultrasonic stirring;
step 2: placing the epoxy resin in an oven and heating at 80° C. until being melted, weighing 80.4 g of the melted epoxy resin, and adding it to the flask in step 1, continuing ultrasonic stirring, and after completion of ultrasonic treatment, placing the flask in an oil bath and stirring to volatilize the acetone at 90° C.;
step 3: grinding 17.6 g of 4,4-diaminodiphenylmethane into fine powder, placing it in a beaker, heating at 120° C. until being melted, and adding it to the flask in step 2; after uniform mixing, pouring the mixture into a mold and drying in an oven at 100° C. and 150° C., respectively, to obtain a composite material, wherein the loading content of the flame retardant is 2 wt % of the total mass of the epoxy resin composite material.
